(19) United States
(12) Patent Application Publication
(10) Pub. No.: US 2011/0120419 A1
(43) Pub. Date: May 26, 2011

(54) Universal Fuel Injector System Having Specific Harness Adaptors

(76) Inventors: Wenbin Xu, Pittsford, NY (US); Jay K. Sofianek, Webster, NY (US)

(21) Appl. No.: 12/625,635

(22) Filed: Nov. 25, 2009

(51) Int. Cl. F02M 61/14

(52) U.S. Cl. 123/470

(57) ABSTRACT

A fuel injector system comprising a universal fuel injector assembly having a universal electrical receptacle, and a family of specific adaptors for connecting the universal fuel injector assembly to a corresponding family of specific engine harnesses and/or design layouts. The universal fuel injector assembly has an injector tip and fuel rail tip compatible with the engine and fuel rail sockets of a plurality of engines. Each adaptor comprises a fuel-injector plug at a first end for mating with the electrical socket and a harness-specific plug or socket at a second end for mating with a specific harness socket or plug.

### TECHNICAL FIELD

The present invention relates to fuel injectors for internal combustion engines; and more particularly, to a system combining a universal fuel injector assembly and a plurality of specific adaptors to permit use of a single fuel injector design for differing designs of internal combustion engines.

### BACKGROUND OF THE INVENTION

Fuel injectors are well known in the engine arts for injection of fuel into either the intake ports or the cylinders of internal combustion engines, both gasoline-fueled and diesel-fueled. To meet different physical requirements of differing engine designs and/or layouts, fuel injector manufacturers must manufacture a multitude of different fuel injectors which may comprise the same basic arrangement of injecting mechanism, injector tip, and fuel rail tip but have differing electrical connector types and locations for mating with differing wiring harnesses of various engine manufacturers. Connector location and orientation may vary based upon an engine and vehicle manufacturer's engine layout and space constraints.

For low volume applications, providing a specifically manufactured fuel injector increases substantially the cost of the fuel injector to the engine manufacturer. For this reason, some fuel injector manufacturers specify a minimum lot size, the cost of which can be prohibitive for a low volume engine application; thus, a significant portion of a potential market can be lost to the fuel injector manufacturer.

What is needed in the art is a system whereby a universal fuel injector assembly can be used in a variety of differing engine designs and layouts.

It is a principal object of the present invention to reduce the cost of manufacturing a family of fuel injectors for differing applications.

It is a further object of the invention to broaden the market available to a fuel injector manufacturer.

### SUMMARY OF THE INVENTION

Briefly described, a fuel injector system in accordance with the present invention comprises a) a universal fuel injector assembly having a universal electrical receptacle, and b) a plurality of adaptors for connecting the universal fuel injector assembly to a corresponding plurality of engine harnesses and design layouts. The universal fuel injector assembly has an injector tip and fuel rail tip compatible with the engine and fuel rail sockets of a plurality of engines. Each adaptor comprises a fuel-injector plug at a first end for mating with the injector electrical receptacle and a harness-specific plug or socket at a second end for mating with a specific harness socket or plug.

### BRIEF DESCRIPTION OF THE DRAWINGS

The present invention will now be described, by way of example, with reference to the accompanying drawings, in which:

FIG. 1 is a schematic drawing of a first embodiment in accordance with the present invention, showing a universal fuel injector assembly, a typical prior art engine wiring harness, and a first embodiment of an electrical adaptor specific to the engine wiring harness; and

FIG. 2 is a schematic drawing of a second embodiment of an electrical adaptor specific to the engine wiring harness.

The exemplification set out herein illustrates a currently-preferred embodiment of the invention, and such exemplification is not to be construed as limiting the scope of the invention in any manner.

### DESCRIPTION OF THE PREFERRED EMBODIMENT

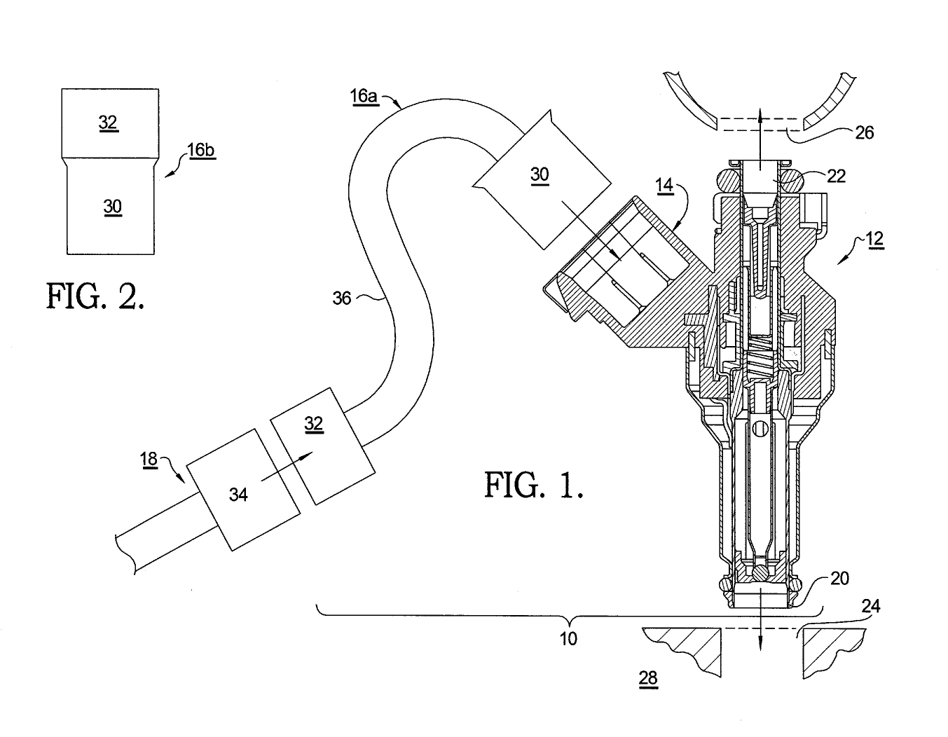

Referring to FIGS. 1 and 2, a fuel injector system 10 in accordance with the present invention comprises a universal fuel injector assembly 12 having a universal electrical receptacle 14 and a plurality of adaptors 16a, 16b for connecting universal fuel injector assembly 12 to any one of a corresponding plurality of engine harnesses 18 and design layouts. Universal receptacle 14 may be formed as an appendage extending from the body of universal fuel injector assembly 12, as shown in FIG. 1, or integrated into the body of universal fuel injector assembly 12.

The term “universal” should be taken to mean being applicable to a plurality of different engine designs having common fuel injector mechanical connections such as injector tip and fuel rail tip. Thus, universal fuel injector assembly 12 has an injector tip 20 and fuel rail tip 22 compatible with the engine and fuel rail sockets 24,26 of a plurality of engines 28 but has differing harness connection requirements across the plurality of engines.

Each adaptor 16a comprises a fuel-injector plug 30 at a first end for mating with universal electrical receptacle 14 and a harness-specific plug or socket 32 at a second end for mating with a specific harness socket or plug 34. In first adaptor embodiment 16a, as shown in FIG. 1, plugs 30,32 are connected by a wiring cable 36 as may be needed or convenient for completing the electrical circuit between harness plug or socket 34 and electric receptacle 14. In second adaptor embodiment 16b, as shown in FIG. 2, plugs 30,32 are connected directly as an integral unit without cable 36 between the plugs.

Adaptor 16a or 16b and fuel injector assembly 12 may be assembled together by known connection methods used in prior art connection of harness sockets or plugs to fuel injectors.

System 10 is useful for all classes of fuel injectors, including gasoline and diesel direct injection and gasoline port injection.

Of course, the universal electrical receptacle of the universal fuel injector assembly need not be limited to what is shown in FIG. 1. The receptacle may assume any suitable shape or orientation on the injector assembly.

Some benefits and advantages of the present invention are:
1. Common tooling of fuel injector components for end use in a wider variety of engine end uses.
2. Flexibility to change connector location and/or fuel injector length with minimal incremental cost in evolving engine and fuel injector designs.
3. Reduced cost of fuel injector assembly and engine assembly.
4. Variable length of adaptor to relieve harness stress in some harness arrangements.
5. Potential for easier fuel injector service assessment.
6. Potential for the manufacturers of low volume engines to utilize fuel injection as a method of fueling the engines, thereby realizing the benefits of better fuel economy and lower emissions.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel injector system for use with a plurality of internal combustion engines having differing wiring harnesses, comprising:
a) a universal fuel injector assembly having a universal electrical receptacle; and
b) a plurality of adaptors for connecting said universal fuel injector assembly to any one of a corresponding plurality of specific engine wiring harnesses.

2. A system in accordance with claim 1 wherein said universal fuel injector assembly includes an injector tip compatible with a plurality of injector sockets on said plurality of internal combustion engines.

3. A system in accordance with claim 1 wherein said universal fuel injector includes a fuel rail tip compatible with a plurality of fuel rail sockets on said plurality of internal combustion engines.

4. A system in accordance with claim 1 wherein each of said adaptors includes a first end for connection to said fuel injector universal electrical receptacle and a second end for connection to a one of said plurality of engine wiring harnesses.

5. A system in accordance with claim 4 wherein said first end includes a plug for mating with said fuel injector universal electrical receptacle, and wherein said second end includes a plug or socket for mating with said wiring harness.

6. A system in accordance with claim 5 further including a wiring cable electrically connected between said first end plug and said second end plug or socket.

7. An internal combustion engine comprising a fuel injector system for use with a plurality of internal combustion engines having differing wiring harnesses, said system including a universal fuel injector assembly having a universal electrical receptacle, and a plurality of adaptors for connecting said universal fuel injector s assembly to any one of a corresponding plurality of specific engine wiring harnesses.
